(19) United States
(12) Patent Application Publication
(10) Pub. No.: US 2019/0009228 A1
(43) Pub. Date: Jan. 10, 2019

(54) ROTATING TUBE MIXER AND METHOD OF MIXING

(71) Applicant: ASHE MORRIS LTD, Warrington Cheshire (GB)

(72) Inventors: Robert Ashe, Runcorn Cheshire (GB); Gary Eccleson, Runcorn Cheshire (GB); Christopher Gaunt, Runcorn Cheshire (GB)

(21) Appl. No.: 16/075,467

(22) PCT Filed: Feb. 10, 2017
(86) PCT No.: PCT/EP2017/053037

§ 371 Date: Aug. 3, 2018

(30) Foreign Application Priority Data
Feb. 12, 2016 (GB) 1602541.3

(51) Int. Cl. B01F 11/00; B01J 19/28; B01J 19/02

(52) U.S. Cl. CPC B01F 11/0002; B01F 11/0077; B01J 2219/0209; B01J 19/02; B01J 19/28

(57) ABSTRACT

A tubular reactor or mixer comprising a tube which can be rotated in reciprocating arcs about its longitudinal axis provided with removable mixing elements (5) within the reactor wherein means (2) are provided to retain the mixing elements within the tubular mixer or reactor so that they move with the movement of the mixer or reactor, the tube preferably also contains mixing elements (7) that are free and do not move with the reciprocation of the tube; processes using the reactor or mixer are included.

### FIELD

The present invention relates to a method and apparatus for mixing fluids in tubes. The method and apparatus may be used for simple mixing of fluids and also for activities which involve reactions involving one or more process materials within the reactor. Relevant fluids include but are not limited to homogenous fluids, gases, supercritical fluids or multi-phase mixtures such as immiscible liquids, gas/liquid mixtures, liquids with solid particles, or combinations of these. The purpose of mixing variously includes but is not limited to intermixing of dissimilar materials or materials of different temperatures, improved heat transfer, improved mass transfer, suspension of particles and promotion of plug flow. Whilst mixing may be used for one purpose, there are commonly two or more reasons for mixing.

### SUMMARY

In this invention, a fluid here is a process material comprising of 45% or greater of free flowing liquid by volume and more preferably 65% or greater. A free flowing liquid is defined here as a liquid which will form a uniform level in a horizontal tube without mixing when introduced through one end of the tube. Examples of fluids include water, toluene and air. The free flowing liquid can carry non fluid materials such as solid particulates subject to the limits described above.

Whilst the present invention can be used for high viscosity fluids it has a limited scope of use in this area. The preferred scope of use is for fluids with a viscosity of less than 1,000 centipoises and more preferably less than 100 centipoises.

Plug flow here is defined as orderly flow which is equivalent to a cascade of 3 stirred tanks in series and more preferably 5 or more stirred tanks in series. In the case of counter-current operation different plug flow streams travelling in opposing directions will exist.

The present invention relates to mixing in general but preferably to systems where materials flow continuously through the tube. These are referred to here as continuous mixing or continuous reaction systems. The term reaction here refers to operations where physical, chemical or biological transformations occur. Transformations include but are not limited to chemical reactions, cell growth, reactions using enzymes or catalysts, extraction and crystallisation. It can also apply to continuous non reaction systems such as blending or material transfer.

Common terms associated with continuous reaction systems are continuous reactors or flow reactors.

In a continuous reaction system, the process materials may flow in co-current mode or counter-current mode. In counter-current mode the process will typically comprise of two or more immiscible fluids of different densities.

Areas where such systems will be used include but are not limited to manufacturing processes for foods, pharmaceuticals, bio processes, fine chemicals, bulk chemicals, petrochemicals, polymerisations and minerals processing.

The preferred use of this invention is as a continuous reaction system which comprises a tube with internal mechanical mixers. Feed materials are fed in at one end of the tube and discharged from the other end in a continuous or intermittent manner. Material transfer into the tube may be by means of gravity, compressed gas in the feed tank or more commonly a pump. In some cases, feed materials may also be added at intermediate points along the tube. Likewise, product or waste materials may be taken off at intermediate points along the tube. In the case of counter current flow, two different phases are added and discharged at different ends of the tube respectively.

According to need, the tube may have a heating/cooling jacket around the outside of the tube. Different designs of heating/cooling jacket can be used based on electrical heating or by means of flowing heat transfer fluids and such methods are known technology. The reactor may use a temperature control system comprising of a temperature measuring device, a control device (such as a control valve) for varying the amount of heating or cooling applied and a controller which regulates the control device based on measured deviations of the process temperature.

Continuous reaction systems are an alternative to batch reaction systems. Their advantages over batch reaction systems stem from the fact that they can process multiple reactor volumes without interruption. This contributes to reduced equipment size and a reduction in high transient heating and/or cooling loads which are encountered with batch reactors during stages of the process cycle. By virtue of smaller size, continuous reactors also give better performance in terms of heat transfer area per unit volume of process material, reduced mixing time and better distribution of mixing shear. Improved performance in terms of mixing and/or heat transfer can contribute to further scale reductions. The combined effects of shorter reaction times, better mixing and better heat transfer variously contribute to improved yield and purity where competitive or consecutive reactions can occur.

The term tube here refers to the mixing tube which contains the process material. Patent WO2014068011 (A2) describes a continuous reaction system whereby the body of the tube is moved in rotating arcs around the long axis of the tube. The long axis of the tube is at right angles to the tube diameter. The tube contains fixed internal mixer blades which rotate with the rotation of the tube. Adjacent to each fixed mixer blade is a moving mixer blade which pivots around the centre point of the tube or near the centre point of the tube. The moving mixer blade is unbalanced by means of a counter weight on one side of the blade and is able to rotate independently of the tube. The counter weight causes the moving mixer blade to resist the rotation of the tube body by the action of gravity. As a result, the fixed and moving mixer blades move independently of each other. This arrangement generates mechanical stirring without the need for a drive shaft in the tube, shaft seals or magnetic couplings.

The present invention provides an improvement in this system that has the benefit of reducing cost and complexity of a rotating tube mixer system.

The invention provides a tubular reactor which can be rotated in reciprocating arcs about its longitudinal axis provided with removable mixing elements within the reactor wherein means are provided to retain the mixing elements within the tubular mixer or reactor so that they move with the movement of the mixer or reactor.

In a preferred embodiment the invention further provides a movable mixer within the tubular mixer or reactor which is free to move independently of the reciprocating movement of the mixer or tubular reactor and to move independently of the fixed mixer.

In a further embodiment the invention provides an assembly comprising a reciprocatable tubular mixer or reactor containing mixing elements removably fixed to the internal wall of the tubular mixer or reactor whereby they are carried by the reciprocal motion of the tubular reactor and further containing a free mixing element moveable within the reactor independent of the reciprocal motion of the tubular mixer or reactor and independently of the fixed mixer.

In a preferred embodiment the free mixing element is retained within the tubular reactor or mixer by a brace which also serves to removably key the fixed mixing element against the internal walls of the tubular mixer or reactor.

The mixing elements or mixers are preferably blade shaped.

### BRIEF DESCRIPTION OF DRAWINGS

FIG. 1 illustrates a tube.

FIG. 2 illustrates a brace.

FIG. 3 illustrates a fixed mixer blade.

FIG. 4 illustrates a moving mixer blade.

FIG. 5 illustrates a mixer assembly.

FIG. 6 illustrates a mixer assembly.

FIG. 7 illustrates a mixer assembly having a baffle.

FIG. 8 illustrates movement of a tube and mixing elements therein.

### DETAILED DESCRIPTION

The invention is illustrated by reference to the accompanying figures.

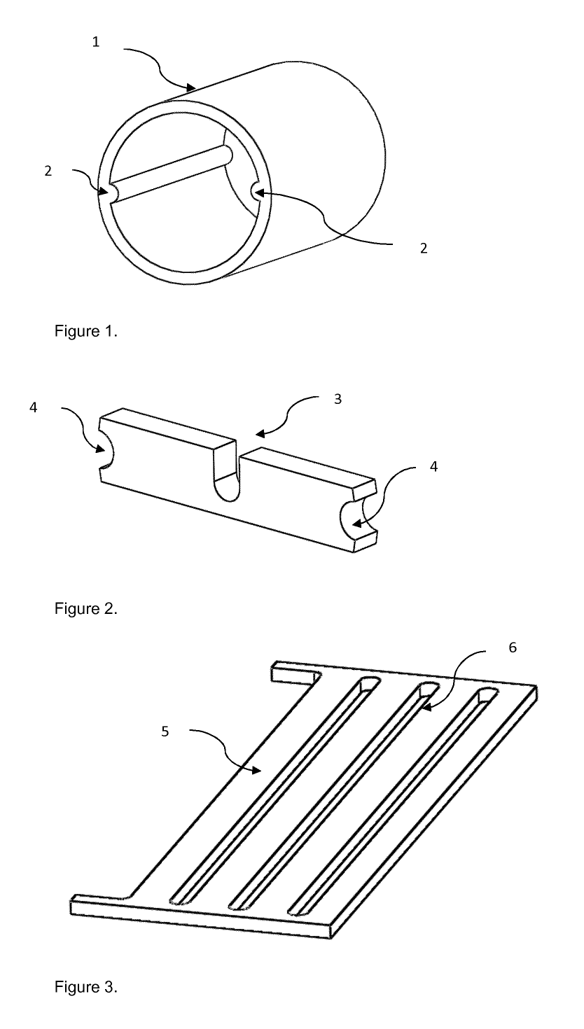

FIG. 1 shows a tube (1) which can contain a process material and is capable of rotation in reciprocating arcs around the long axis of the tube. The feed and discharge lines for delivering and removing process material at the tube ends are not shown. A cooling/heating jacket is not shown. The tube end plates for sealing the tube are not shown. Tube side supports (2) on each side of the tube keep the fixed mixer blades stationary relative to the tube. An additional purpose of the tube side supports can be to carry the weight of the moving mixer blades which are mounted on pivots.

FIG. 2 shows a cross brace (3) which can be used to hold the fixed mixer blades stationary relative to the tube. Slots (4) in the cross brace locate the cross brace on the tube side supports (2). The cross brace is free to slide along the tube. Part of the pivot mechanism for a moving the mixer blade is shown as the central slot on the cross brace and this allows the moving mixer blade to rotate independently of the fixed mixer blades. This part of pivot mechanism can be round to suit a circular pivot element as shown or may be a flat or profiled surface to support a narrow edge rocking on said surface.

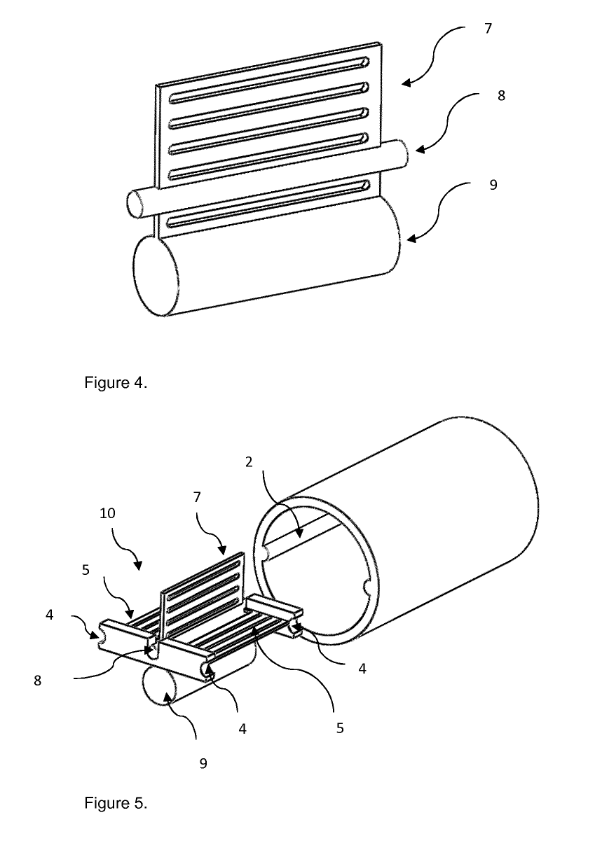

FIG. 3 shows a fixed mixer blade (5) which can be located on the cross brace by means of welding, fusing, bonding with glue, screws, slots, clips, a frame or a combination of these. The cross brace and fixed mixer blades may also be formed as a single piece by means of machining or casting or a combination of these. Slots (6) are shown on the fixed mixer blade to allow process material to pass across the face of the fixed mixer blade for mixing. The slots will vary in number, size and shape according to need. In some cases holes rather than slots will be used. In some cases the fixed mixer blade will be a solid sheet without holes or slots.

FIG. 4 shows a moving mixer blade (7) which is supported on a pivot mechanism (8) which is round to facilitate rotation. Alternatively the pivot mechanism may be a sharp or round edge rocking on a surface. A counterweight (9) is located on one edge of the moving mixer blade. The combination of free rotational movement and a counterweight allows the moving mixer blade to have a different rotational travel to the fixed mixer blade.

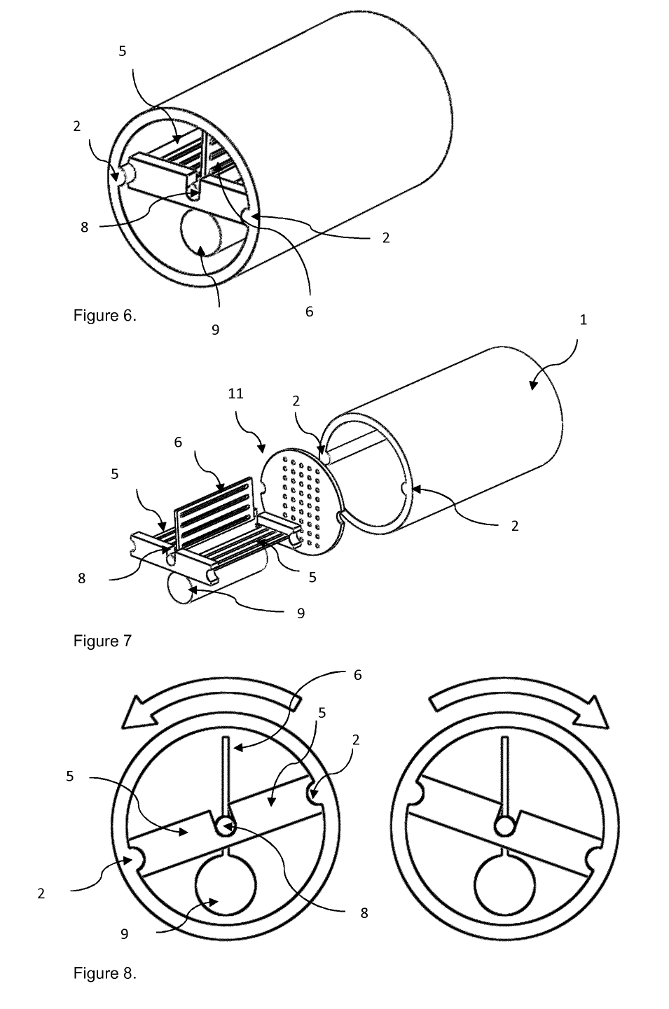

FIGS. 5 and 6 show how the components are combined as a mixer assembly (10) and how the assembly can be inserted into the tube. The mixer assembly is free to slide along the tube side supports (2) for installation. The figures show a single mixer assembly. In a batch system a single or multiple mixer assemblies may be used. In a continuous reaction system, 3 or more mixer assemblies are preferred and more preferably 5 or more and even more preferably 8 or more mixer assemblies. The reason that multiple mixer assemblies are preferred in a continuous system is that high tube length in relation to tube diameter gives good plug flow.

Multiple short mixer assemblies are easier to handle and also facilitate multiple baffles where required to minimise back mixing. Mixer assemblies may be installed as a single assembly or as multiple separate components.

FIG. 7 shows the mixer of FIG. 5 provided with an additional component which is a baffle (11). This is used in some applications to reduce or eliminate back mixing between mixer assemblies. Subject to a sufficient number of baffled stages this achieves plug flow where the desired length to diameter ratios of the tube is impractical. The baffle is sufficiently thick to be held in position by the geometry of the tube with side supports (2) but it can slide along the tube for installation. The thickness of the baffle will vary according to the strength of the material used.

FIG. 8 illustrates how the fixed mixer blade moves independently of the static mixer blade as the tube rotates in arcs.

The figures in this description are illustrative and the assemblies of the invention can be fabricated and assembled in different ways. The key elements which facilitate this arrangement are keying elements which hold the fixed mixers such as the tube side supports (2). These provide the means for keeping the fixed mixer blades stationary relative to the tube during rotation and can provide support for one or both types of mixer blade. The cross brace (3) can be an independent part or part of the fixed mixer blade (6), or part of the baffle (11) or a combination of these.

The keying elements to retain the mixing element may be protrusions along the inner surface of the tube or they may be slots in the wall of the tube into which protrusions in the mixers can fit. A single protrusion or slot may be used, although two or more protrusions or slots may be used. The preferred number of protrusions or slots is two.

The tubular reactor or mixer rotates in reciprocating arcs of up to 180° in each direction but the preferred arc of rotation is 90° or less in each direction. It is preferred that the keying elements such as protrusions or slots are orientated such that they are in a horizontal position at the mid-point of the arc of travel of the tube as is shown in FIG. 6. It is preferred that the protrusions or slots are on opposite sides of the tube at the full diameter which is 180°. Where they are offset from 180°, it is preferable that this is less than 40° from the 180° position.

Different numbers of mixer blades can be used but the preferred arrangement is a fixed mixer blade extending across at least most of the width of the tube and one moving mixer blade. The width of the mixer blade refers to the dimension across the diameter of the tube. The length of the mixer blade refers to the length along the long axis of the tube. The width of the mixer blades are preferably greater than 40% of the tube diameter and more preferable greater than 60% of the tube diameter and even more preferably greater than 80% of the tube diameter. The width of the moving mixer blade is smaller than the internal diameter of the tube to ensure free rotation. It is preferred that clearance between the moving mixer blade and the tube wall is 2 mm or greater at the top and 5 mm or greater at the bottom. Larger or smaller clearances will be required according to application. The length of the mixer blades will depend on the maximum length that is practical for installation and material strength. The length of the mixer blades may alternatively be dictated by the number of mixing stages required where baffles are used for stage separation.

It is preferred that the static and moving mixer blades in a mixing assembly substantially occupy the same length of tube as shown in FIG. 5. For practical reasons, the length of the moving mixer blade will generally be shorter than the fixed mixer blade so as to allow free rotation. The purpose of having the mixer blades occupy the length of tube is to create volumetric spaces between the static and moving blades. As the angle between the blades changes, process material passes through holes and slots or the side gaps in the blades to generate mixing.

The reciprocation of the tube may be driven in different ways but the preferred method is belt driven.

It is preferred that removable sealing plates are provided at at least one end of the tube and more preferably both ends of the tube. When the plate or plates are removed from the end or ends of the tubes, access to the full internal diameter of the tube is required for insertion or removal of the mixing assemblies.

Different materials of construction can be used and the two key requirements are adequate mechanical strength and compatibility with the process material so as to resist the effects of corrosion and/or erosion. For some applications the tube will be fabricated in glass lined steel. It can also be fabricated in a variety of other materials according to need. Examples include stainless steel, hastelloy, carbon steel, plastic lined steel, tantalum lined steel, exotic metals or alloys, ceramic materials, glass, plastic and reinforced plastic.

The components of the mixer assembly can be fabricated in the same materials as the tube as described above. Given that the mechanical stresses on the mixer assembly however are generally lower, greater use of non-metal materials can be exploited such as PVDF, PTFE, polypropylene polyimides preferably fibre filled and composites of these materials.

The operating temperature and pressure that should be employed within the tube will vary according to the mixing or reaction application involved. As a general comment and subject to the right choice of materials and thicknesses, this mixing system will handle a wide range of pressures from full vacuum to 300 bar or greater. Similarly it will handle temperatures below 100° C. to greater than 300° C.

A high ratio of tube length to diameter is preferred to keep feed material separate from the product. The tube length is preferably equal to or greater than 4 times the diameter and more preferably equal to or greater than 6 times the diameter and even more preferably equal to or greater than 8 times the diameter. The higher length to diameter ratios brings the benefit of flow throughout the mixer or reactor that is closer to plug flow.

The speed of rotation of the tube will vary from less than 1 cycle every 10 minutes to more than 1 cycle per second according to need. A cycle here refers to two complete arcs of rotation such that the mixing blade returns to its original position. For mass transfer limited processes the preferred rotation speed is greater than 1 cycle per 4 seconds and more preferably greater than 1 cycle per 2 seconds and even more preferably greater than 1 cycle per second. For reactions with homogenous fluids the minimum rotation speed should be greater than 1 cycle per 4 seconds and even more preferably greater than 1 cycle per 2 seconds.

The preferred tube diameter will vary according to the required volumetric capacity per unit length and also the required ratio of heat transfer area to volumetric capacity. The preferred diameter is less than 500 mm and more preferably less than 300 mm. Tubes which are larger than 500 mm in diameter may also be used.

The feed and discharge tubes need to accommodate the rotational movement of the tube. The preferred solution for this is to use flexible hoses. Other methods may be also be used such as solid pipes with sufficient length and bends to accommodate the movement. Centrally mounted tubes with rotating seals may also be used. Similar arrangements to the above are also required where heat transfer fluid is used.

Where the keying elements are protrusions the shape of the protrusions can be varied according to need and can be a variety of profiles and include but not limited to square, rectangular, rectangular with a lip, semi-circular (as shown in FIG. 1) or variations on these. The cross sectional area of the protrusions will vary according to need. This will be determined based on engineering principles taking account of the forces applied, the diameter of the tube and the strength of the cross brace material. The keying elements may be in one or multiple locations along the tube but more preferably they are continuous along the length of the tube to make insertion of the mixer assemblies simpler. The location means within the tube can also be made as a groove cut into the tube. The groove shape can be cut in a variety of profiles and include but not limited to square, rectangular, rectangular with a lip, semi-circular or variations on these.

Where protrusions are used they may be fixed to the tube with bolts or screws and may also be fixed by other means such as adhesives or bonding. It is preferred however to weld the protrusions to the tube. This may be done by welding on the tube in situ or by cutting the tube longitudinally or into sections and welding the protrusions onto the internal of the tube and then recombining the pieces of the tube.

The mixer assemblies can be slid in and out via the tubes ends when the tube end plates are removed. When the mixing assemblies are removed, the tube is empty and easy to clean. The mixer assemblies can be slid into the tube and held in the required position without screws or other types of fixing element. The mixer assemblies are prevented from moving along the tube by virtue of being pressed together within the tube. This can be achieved by a variety of methods such as restricted movement by virtue of the tube end plates, springs, spacers or other such means.

The pivot points for the moving mixing blades can employ sleeves or wear pads on the moving parts, on the non-moving parts or both. These can serve to reduce the resistance to rotation and also as low cost replacement parts.

It is preferred that the arc of rotation of the tube is near to the central axis of tube and more preferably at the central axis. The preferred position of the pivot mechanism which carries the moving mixer blade is near the central axis of the tube rotation and more preferably at the central axis. This facilitates larger diameter moving mixer blades and efficient rotational movement of the moving mixer blades.

By virtue of the length to diameter ratios combined with active mixing described herein, this is a continuous reaction system which gives conditions close to plug flow. By virtue of using 5 or more mixer assemblies separated with baffles combined with mechanical stirring this is a continuous reaction system which gives plug flow independently of tube length to diameter.

By virtue of mechanical stirring by the means described above, the full working volume of the tube between the inlet and discharge points is subject to mixing and unmixed zones can be eliminated where required. This provides good mixing performance and permits the handling of solid particles and other multiphase mixtures.

The arrangement described herein provides efficient mixing with a high ratio of swept volume. It also eliminates the need for rotating drive shafts inside the tube, mechanical seals and magnetic couplings.

1. A mixing system comprising,
a) a tube;
b) one or more keying elements as part of the tube to retain one or more mixing elements within the tube; and wherein the tube rotates in reciprocating arcs around a longitudinal axis of the tube and the one or more mixing elements move with the tube.

2. The mixing system according to claim 1, wherein the one or more keying elements are protrusions.

3. The mixing system according to claim 1, wherein the one or more keying elements are slots.

4. The mixing system according to claim 1, wherein the mixing system contains at least one mixer assembly comprising a fixed mixer and a moving mixer; and
wherein a position of a fixed mixer blade of the fixed mixer relative to the tube is held in position by the one or more keying elements.

5. The mixing system according to claim 4, wherein the fixed mixer is supported by two or more of the one or more keying elements.

6. The mixing system according to claim 4, wherein the fixed mixer is held in position by a cross brace which engages with the one or more keying elements.

7. The mixing system according to claim 1, wherein a mixing assembly can be slid into position in the tube from an end of the tube; and
wherein the mixing assembly remains in a required position without mechanical fastenings between the mixing assembly and the tube.

8. (canceled)

9. The mixing system according to claim 1, wherein the mixing system is a tubular reactor comprising:
the tube which can be rotated in reciprocating arcs about the longitudinal axis of the tube;
ii) the one or more mixing elements in the tube and which are removable; and
wherein means are provided to retain at least one of the one or more mixing elements fixed within the tubular reactor so that the at least one of the one or more mixing elements move with movement of the tubular reactor.

10. The mixing system according to claim 9, wherein the tubular reactor comprises a movable mixer blade within the tubular reactor which is free to move independently of a reciprocating movement of the tube.

11. An assembly comprising:
a) a tubular reactor;
b) one or more mixing elements contained within the tubular reactor and removably fixed to an external wall of the tubular reactor, wherein the one or more mixing elements are carried by a reciprocal motion of the tubular reactor; and
c) a free mixing element movable within the tubular reactor independently of the reciprocal motion of the tubular reactor.

12. The assembly according to claim 11, wherein the free mixing element is retained within the tubular reactor by a brace, and
wherein the brace also removably holds the one or more fixed mixing elements to the internal wall of the tubular reactor.

13. The mixing system according to claim 1, wherein the tube is made of a glass lined steel.

14. A method of mixing in a reactor comprising:
i) feeding a process material to one end of a tube, wherein the tube is rotating in reciprocating arcs about a longitudinal axis of the tube;
ii) withdrawing a material from another end of the tube;
wherein the tube contains one or more mixing elements within the tube and which are removable from the tube, and wherein the one or more mixing elements move with a movements of the reactor; and
wherein the tube contains a moveable mixer within the tube which is free to move independently of a reciprocating movement of the tube.

15-17. (cancelled)

18. A method according to claim 14, wherein a length of the tube is equal to or greater than four times a diameter of the tube.

19. A method according to claim 14, wherein a reciprocal rotation of the tube is greater than 1 cycle for 4 seconds.
